(19) United States
(12) Patent Application Publication
(10) Pub. No.: US 2012/0072835 A1
(43) Pub. Date: Mar. 22, 2012

(54) Microblog Client

(75) Inventors: William Gross, Pasadena, CA (US); Girish Venkat, Pasadena, CA (US); Jamie Belsky, Los Angeles, CA (US); Jon Kraft, Los Angeles, CA (US)

(73) Assignee: UBERMEDIA, INC., Pasadena, CA (US)

(21) Appl. No.: 13/237,192

(22) Filed: Sep. 20, 2011

Related U.S. Application Data
(60) Provisional application No. 61/403,728, filed on Sep. 20, 2010.

(51) Int. Cl. G06F 17/00

(52) U.S. Cl. 715/243

(57) ABSTRACT

Methods, computer readable media, and apparatuses for providing user interfaces, determining screen layouts, and displaying microblog posts are presented. A microblog client may receive a set of microblog posts and provide a user interface for displaying the received microblog posts. The microblog client also may parse the received posts and identify one or more content elements within the posts. The microblog client may then download additional information based on the content elements, and may determine a screen layout for displaying the posts based on the content elements and the additional downloaded information. In certain examples, microblog posts may be parsed and the additional related information may be downloaded prior to the selection of the posts in the user interface. The determination of a screen layout for displaying the microblog posts may also depend on the display characteristics, for example, screen size or orientation of a client device.

### RELATED APPLICATIONS

The present application is a non-provisional of U.S. Patent Application No. 61/403,728, entitled “Microblog Client with User Interface for Mobile Devices,” filed Sep. 20, 2010, the contents of which are incorporated herein by reference in their entirety for all purposes. Additionally, the contents of co-pending U.S. patent application Ser. No. 13/048,823, entitled “Systems and Methods for Interacting with Messages, Authors, and Followers,” filed Mar. 15, 2011, are also incorporated herein by reference in their entirety for all purposes.

### BACKGROUND

Microblogging refers to a form of sending and receiving content between users in which authors post short written messages through websites, desktop applications, or mobile clients, and the messages are made available for viewing by other users, such as the author's friends, contacts, followers, or subscribers, etc. The short messages, or posts, in microblogging may take the form of short message service (SMS) messages which are limited to 140 characters in length. Microblog posts may be composed, submitted, and viewed through a variety of different microblog clients, for example, microblogging websites, mobile device microblogging applications, and/or desktop client applications. Posts may consist of text only and/or may include links to webpages, pictures, or videos, etc. Microblogging websites may be used to communicate socially, but may also be used by public figures and organizations to report on current events, news, and observations in real-time or near real-time.

Current microblogging websites, for example, Twitter, Plurk, and Tumblr, allow users to communicate with others in the user's circle of “friends” or “followers.” When a user creates and submits a microblog post, the post is made available to each of the user's followers, allowing the followers to keep up with the thoughts and activities of the author of the post. Authors may restrict delivery to those in their circle of friends, or may allow the public to view their microblog posts. Users can also select a set of other users to follow, so that they will receive posts authored by the users they are following. Followers may view the messages of the users they are following through an account at a microblogging website or a microblog client application which may provide a user interface that displays a lists of posts from the authors being followed by that user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to methods, computer readable media, and apparatuses for providing a user interface and displaying one or more microblog posts on a microblog client device. A microblog client device, for example, a personal computer, laptop, or mobile device, may receive a set of microblog posts from a microblog server and provide a user interface for displaying the received microblog posts. The microblog posts may be displayed in various views and screen layouts selected by the microblog client. In certain embodiments, a microblog client application may parse a set of received microblog posts and may identify one or more content elements in the posts, such as, for example, links, username mentions, and content tags within the text of the posts. After parsing one or more microblog posts, the microblog client may determine a screen layout for the posts based on the content elements, if any, identified within the posts. For example, for a microblog post containing a link to a webpage, the microblog client may download the target webpage and provide a user interface having a screen layout that displays the microblog post and a preview of the target webpage in different windows in the same user interface.

According to one or more aspects, the user interface screen layouts selected for displaying one or more microblog posts may also be based on characteristics of the client display device. For example, a microblog client may detect certain hardware characteristics and settings of the client device's display screen (e.g., display monitor type, screen size) to use when determining and selecting a user interface for displaying microblog posts. Additionally, if the microblog client is a mobile device, then one or more additional characteristics, such as, for example, the screen orientation (portrait or landscape) and various screen capabilities (e.g., touchscreen, drag-enabled, swipe-enabled, etc.) of the mobile device when determining and selecting a screen layout for displaying the microblog posts.

According to additional aspects, a microblog client may parse microblog posts and/or download additional information related to the posts, prior to the selection of the posts in the user interface. If a microblog client application receives and parses a microblog post and identifies one or more content elements in the post, the client application may determine additional information to download based on the content element, for example, target webpages corresponding to links, user profiles, related posts, and other information related to the microblog post. The microblog client may download and store such additional information before the microblog post is selected by a user, thereby potentially reducing latency when the post is selected and enhancing the overall user experience while browsing and viewing microblog posts.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing environment, including a microblog client device and microblog server, in which various aspects of the disclosure may be implemented.

FIG. 2 is a functional block diagram illustrating a microblog client device in accordance with one or more illustrative aspects described herein.

FIG. 3 is a flow diagram illustrating a method of determining user interface screen layouts and displaying microblog posts in accordance with one or more illustrative aspects described herein.

FIG. 4 is a flow diagram illustrating a method of determining user interface screen layouts and displaying microblog posts on a client mobile device in accordance with one or more illustrative aspects described herein.

FIGS. 5-17 illustrate examples of computer user interfaces having screen layouts for displaying microblog posts in accordance with one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

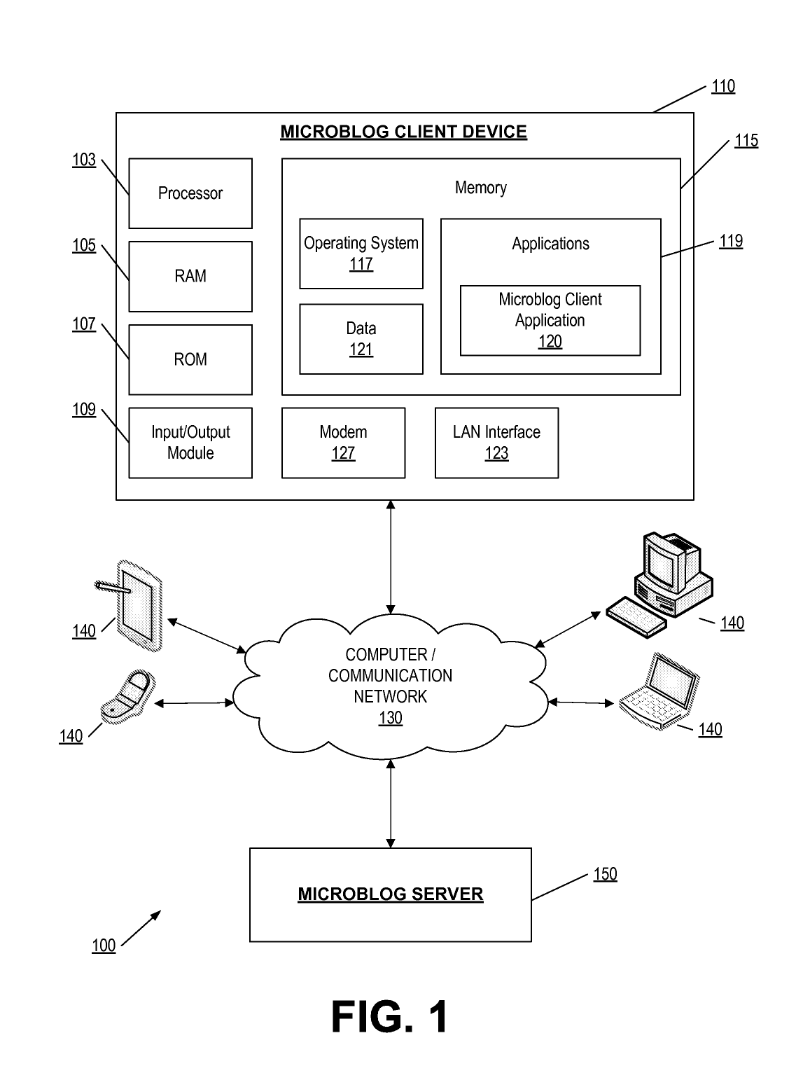

FIG. 1 illustrates an example block diagram of a generic computing device 110 (e.g., personal computer, mobile device, smart phone, or personal digital assistant, etc.) in an example computing environment 100. Computing device 110 may be used in accordance with one or more illustrative embodiments of the disclosure, for example, as a microblog client computing device configured to receive microblog posts and provide a user interface for users to view, compose, and send microblog posts. In other examples, the computing device 110 may be configured as a microblog server for receiving, storing, and providing microblog posts and other content to various users and/or devices.

The computing device 110 (e.g., microblog client computing device) may have a processor 103 for controlling overall operation of the device and its associated components, including random access memory (RAM) 105, read-only memory (ROM) 107, input/output (I/O) module 109, and memory 115. I/O module 109 may include a microphone, mouse, keypad, touch screen, scanner, optical reader, and/or stylus (or other input device(s)) through which a user of the microblog client computing device computing device 110 may provide input, and may also include one or more of a speaker for providing audio output and a video display device (e.g., an attached monitor for a personal computer, integrated screen for a mobile device, etc.) for providing textual, audiovisual, and/or graphical output. Software may be stored within memory 115 and/or other storage to provide instructions to processor 103 for enabling computing device 110 to perform various functions. For example, memory 115 may store software used by the computing device 110, such as an operating system 117, application programs 119, and an associated database 121. Alternatively, some or all of the computer executable instructions for computing device 110 may be embodied in hardware or firmware (not shown).

The microblog client computing device 110 may operate in a networked environment supporting connections to one or more remote computers, such as microblog server 150 and terminals 140. The computing device 110 may be connected to a local area network (LAN) via a LAN interface or adapter 123, and/or a wide area network (WAN) via a modem 127 or other network interface for establishing communications over the WAN, to establish communications with one or more computer/communications networks 130 (e.g., the Internet or any other suitable computer or communication network). It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

The microblog server 150 and terminals 140 may be personal computers, servers, mobile devices, or other computing devices that include some or all of the elements described above with respect to the generic computing device 110. In this example, the microblog server 150 may host a microblogging website that provides an interface through which social network users can exchange and search microblog posts. A user may be an author when composing and submitting microblog posts, and a follower when viewing the posts of others. An author may generate posts in different ways and from different client devices 110, for example, from a mobile device, through a desktop application, or through a webpage hosted by a microblogging website provided by the server 150. As followers, users may also view posts via mobile devices, desktop applications, and a personal account at a microblogging website provided by the server 150. The microblog server 150 may include an account manager and database for maintaining user accounts and storing user information including user names, passwords, contact information, lists of authors that each user follows, and lists of each user's followers and their profile information. The microblog server 150 may also include a microblog manager for receiving incoming posts and storing those posts to a database or other data store where they may be made available to followers.

In the example computing environment 100, computer/communication network 130 (along with one or more additional networks used in certain embodiments) may be any suitable computer network including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communication network 130 may include other suitable communications networks such as cable networks, dial-up or wireless cellular telephone networks, satellite networks, etc.

As noted above, in some examples, the microblog client computing device 110 and/or terminals 140 may be mobile terminals (e.g., mobile phones, smartphones, personal digital assistants, notebook computers, etc.) including various other components, such as a battery, speaker, and antennas (not shown). Additionally, a microblog client mobile device may include an orientation sensor (e.g., an accelerometer, tilt sensor, etc.) to detect the orientation of the device 110 to align the screen depending on the direction the device is held, for example, switching between portrait and landscape modes.

According to one or more aspects, the devices and networks of computing environment 100 may be configured to provide a system for creating, transmitting, receiving, and viewing microblog posts and related content. Various functionality of a microblog system computing environment 100 may be located within the server 150 and/or may be located remotely from the server 150. For instance, microblog client 110 and/or terminal devices 140 may be configured with client-side functionality to request and receive microblog posts from the server 150, and to provide a software user interface to allow users to view and author microblog posts and perform additional microblogging functionality. In this example, the computing device 110 includes a microblog client application 120 to perform the client-side microblogging functionality. The microblog client computing device 110, like the various other client devices 140, may be a personal computers, laptop computer, mobile devices (e.g., tablet computers, smartphones, PDA's, etc.) or any other type of computing device configured with client-side microblogging functionality. It should be understood that mobile client devices may have limited functionality (e.g., displays, input/output) compared to other client computing devices, and thus the user interface features and other client functionality may be limited for mobile client devices.

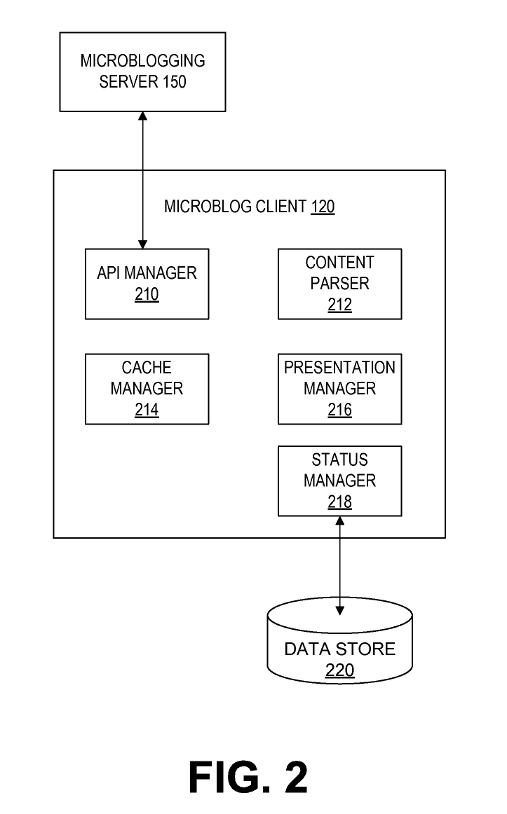

Referring now to FIG. 2, a functional block diagram is shown of an illustrative microblog client software application 120. The microblog client application 120 in this example includes several components of the client-side microblog functionality of a microblog client device 110, for example, an application programming interface (API) manager 210, a content parser 212, a cache manager 214, a presentation manager 216, and a status manager 218, one or more of which may be coupled to a data store 220. The API manager 210 component of the client application 120 may encapsulate the communications with the microblog server 150. In particular, the API manager functional component 210 may be used by the client application 120 to submit and request microblog user account information from the server 150 for an authenticated (e.g., logged-in) user at the client device 110. User account information may include, for example, the user's username, password, a list of the user's followers, a list of authors followed by the user, a set of microblog posts associated with the user (including posts authored by the user as well as by other authors followed by the user), replies to posts, lists of posts that have been re-posted, and direct messages. The content parser functional component 212 may be configured to parse and extract the data from incoming microblog posts, including, but not limited to, one or more of the following elements: uniform resource locators (URLs), shortened URLs that link to a website (e.g., bit.ly URLs which may be translated into full URL equivalents), mentions or attributions (e.g., @mention's that identify a username in the body of a microblog post), and content tags (e.g., #tags) identifying a keyword or topic associated with microblog posts and/or used by users to categorize their posts, and other content or metadata in or associated with microblog posts. The cache manager functional component 214 may be configured to download and store the content of microblog posts and additional related content (e.g., referenced links or URLs, user profiles, and/or other related posts). The presentation manager functional component 216 may be responsible for determining a preferred layout for the client device 110 for rendering a set of microblog posts and/or corresponding related data for the posts based on the content of the posts, the cached data, and characteristics of the display of the client device 110 (e.g., screen size, shape, and display orientation). The status manager functional component 218 may determine and track the status of each microblog post received at the microblog client application 120, for example, whether a post has been (a) read or not, (b) read but marked unread, or (c) previewed or not. The status information may be stored locally in the data store 220. This information may be uploaded to the server 150, for example, at the end of each session, and may be synchronized with other devices (e.g., client devices 140).

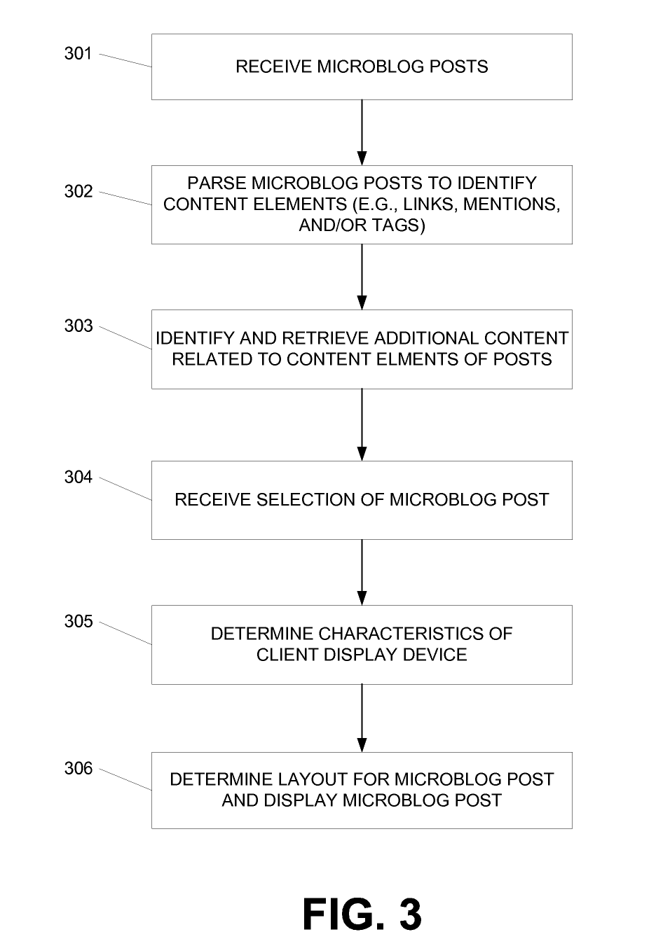

FIG. 3 illustrates a flow diagram for determining a layout and displaying microblog posts in a computer user interface, according to one or more illustrative aspects described herein. The embodiments described in reference to FIG. 3, and the other embodiments described herein, may be implemented by software executed on one or more computers, such as the microblog client computing device 110 of FIG. 1. As noted above, the microblog client computing device 110 may be a personal computer, laptop, mobile device, or other computing device configured for viewing microblog posts. In certain arrangements, the methods described herein may be performed by and/or in combination with a server (e.g., microblog server 150).

In step 301, a computing device (e.g., microblog client 110) may receive a plurality of microblog posts, for example, from a microblog server 150. The microblog client 110, for example, a personal computer or mobile device, may request microblog posts by initiating a microblog client application 120 or by accessing a microblogging website. For instance, a user may commence a microblogging session by authenticating (e.g., logging-in) to the microblog client application 120 or client website 120, at which time the application 120 may automatically request and retrieve information from microblog server 150 including a set of posts of interest to the user. For example, the server 150 may transmit to the client 110 a set of recent microblog posts (e.g., in reverse chronological order from the present time) authored by users being followed by the current user or relating to subjects that the current user is interested in.

In step 302, the microblog client 110 may parse the received microblog posts to identify certain content elements within the posts. A content element may refer to any recognizable feature of a microblog post that can be identified and used to retrieve additional information not included in the post itself. For example, a microblog post may include one or more links to network resources, such as uniform resource locators (URLs) or short URLs (e.g., bit.ly URLs which may be translated into full URL equivalents) that refer to Internet websites, images, videos, or other local or remote network resources. Posts also may include mentions or attributions that refer to other microblog users (e.g., @username) or other people. A mention may refer to the author of the post, or may be a name found within the text of the post. Microblog posts may also include content tags (e.g., #tags) that identify a keyword or topic associated with the post. Authors and readers may use content tags to categorize their posts and to search for posts relating to a specific topic or containing specific data.

To identify content elements in posts, the microblog client 110 may parse the individual posts and identify specific characters or patterns of characters that indicate a content element. For example, microblogging systems may use a specific predefined link format (e.g., bit.ly URL) that may be searched for within posts. In certain examples, mentions may be identified with the “@” character followed by a username, and content tags may identified with the “#” character followed by a topic or keyword. In other examples, special characters need not be used, and the microblog client may independently analyze the text of the post and/or header information to identify names, places, events, and topics, etc., that may be designated by the client 110 as mentions or content tags.

In step 303, the microblog client 110 may download additional information (i.e., information not included in the microblog posts) based on the content elements identified in the posts. In certain examples, the additional information for a microblog post may be downloaded before the post is selected (e.g., clicked-on) by a user. As an example, the microblog client 110 may be configured to download and parse a predetermined number of microblog posts in step 302, and then download a set of additional information relating to the content elements found in the posts in step 303, prior to the posts being selected by the user in step 304. By pre-downloading this additional information related to posts, a microblog client 110 potentially may reduce latency and enhance the viewing experience for users while browsing microblog posts.

For example, if a microblog client 110 parses a microblog post and identifies a link to a webpage in the post in step 302, then the client 110 may proceed to download the webpage in step 303. As discussed below, the client 110 may also download additional related webpages, for example, other webpages linked-to by the webpage, other pages within the same website, or other webpages discussing the same topic. If a microblog post includes a mention or attribution, then the client 110 may retrieve additional information about the person mentioned in the post, for example, user profile information or biographical information from the microblog server 150 or information from another external source (e.g., Internet search engines, web resources, etc.). If a microblog post contains a content tag identifying a keyword, topic, or category associated the post, then the microblog client 110 may retrieve various types of additional information relating to the content tag. For example, the client 110 may retrieve additional recent posts from the microblog server 150 that include the same content tag, have the same keyword, or relate to the same topic. Additionally, the client 110 may retrieve information about the content tag from an external source (e.g., Internet search engines, etc.).

It should be understood that the steps of receiving and parsing microblog posts (step 302) and pre-downloading additional related content based on content elements identified in the posts (step 303) are optional and need not be performed in certain embodiments. For example, microblog client 110 may be user-configurable to enable or disable the pre-downloading of any additional content related to the received posts. In this example, users may prefer to disable pre-downloading features at certain times to conserve network bandwidth, device power, or for other various reasons. In this case, a microblog post and/or any additional content related to the post might not be downloaded by the client 110 until the post itself is selected for viewing by a user.

When the receiving and parsing of microblog posts and/or pre-downloading additional related information based on content elements within the posts are enabled, these features may be customized based on user inputs and preferences. For example, a user may predefine a number of microblog posts to retrieve and/or the types and amounts of any additional information related to the post that should be downloaded to the microblog client 110 prior to the selection of the post. These settings may also be determined automatically, for example, based on the current network connection speed, the current available memory and/or available processing power at the client device 110, and other factors. For instance, a client device 110 may be configured to parse and identify content elements in a set of retrieved microblog posts in step 302, and then to download a partial preview of the additional related content without downloading the entire related content in step 303. For example, if a microblog post contains a URL link to a webpage, the downloaded preview may include the complete webpage or only a portion of the webpage. If a post includes a link to an image, then the downloaded image preview may include the complete image or a lower resolution or thumbnail version of the image. If a post includes a link to a video, then the downloaded video preview may include the complete video or only a single video frame or a subset of video frames. In these examples, the preview of additional content downloaded in step 303 may be displayed to the user either before or after the microblog post is selected for viewing, and the complete version of the additional related content (e.g., complete webpage, complete image or video, etc.) might only be downloaded once the user selects the additional related content for downloading (e.g., clicks-on the webpage URL, selects the image or video, etc.)

In step 304, the client device 110 receives a selection of a microblog post via the user interface. The type of selection user input received may depend on the client device 110 hardware and/or the microblog client user interface. For example, a user in a microblogging website 120 may select a post by mouse-clicking or via a keystroke, while a user of a microblog client application 120 on a mobile device 110 may use a screen tap or swipe to select a post or advance to a next post. Additionally, a microblog post may be automatically selected by the microblog client application 120. For example, as discussed below, in certain user interfaces the first (e.g., most recent) microblog post retrieved from the server may be automatically selected and displayed upon opening the microblog client application 120.

In step 305, the microblog client 110 may determine one or more characteristics of the client display device. The display device characteristics may relate to the hardware characteristics of the client device 110, for example, the display type (e.g., monitor, projector, or integrated display screen) and/or screen size (e.g., various mobile device screen sizes, tablet computers, laptop and desktop computers, etc.). Additionally, if the microblog client 110 is a mobile device then one or more additional display characteristics may be retrieved in step 305, such as the screen orientation (portrait or landscape) and various screen capabilities (e.g., touchscreen, drag-enabled, swipe-enabled, etc.). The display device characteristics also may relate to the portion of the screen available for the microblog client application 120. For example, the microblog client 110 may determine the current size and shape of its application window on the user's screen, and may use those dimensions rather than the screen size when determining the screen layout for displaying the microblog posts in step 306.

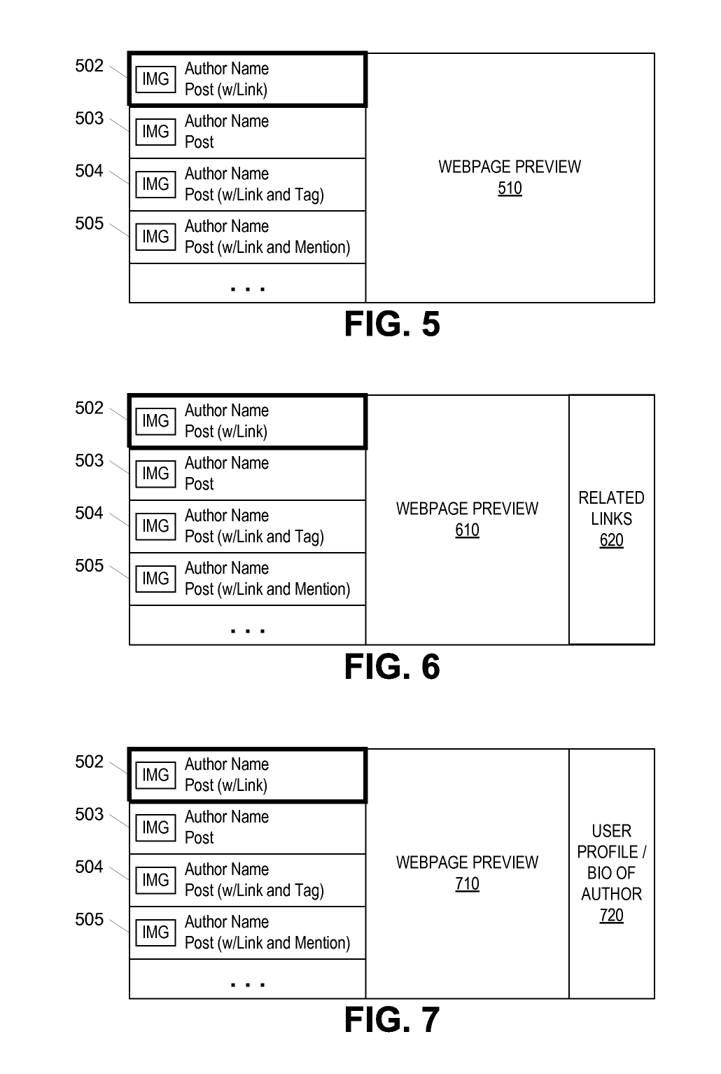

In step 306, the microblog client 110 may determine a screen layout for the selected microblog post and display the post in the user interface in response to the user-selection in step 304. In certain embodiments, the screen layout determined for the selected microblog post may be based on the number and type of content elements identified for the post in step 302 and/or the information retrieved in step 303. Microblog posts that include content elements, such as links, mentions, and content tags, may be displayed in a user interface that includes the additional data corresponding to their content elements. For example, the selected layout for a microblog post including a webpage link may include a dedicated portion of the screen for showing a preview of the target webpage. Examples of different microblog post layouts are shown in FIGS. 5-17. As shown in these examples, microblog posts containing different sets of content elements, or containing no content elements, may be laid out and displayed differently based on the numbers and/or types of content elements in each post.

The layout selected for a microblog post in step 306 also may be determined by whether any additional pieces of data corresponding to the content elements in the microblog post have been pre-downloaded as described in step 303. For instance, as described above, a pre-downloaded preview of a webpage, image, or video corresponding to a link a microblog post may be displayed when the post is selected, in order to enhance the user experience. However, if a user has disabled pre-downloading of content for microblog posts containing links, then the client application 120 may determine that a preview window showing the target webpage should not be displayed in order to avoid reduce load time and/or save network bandwidth.

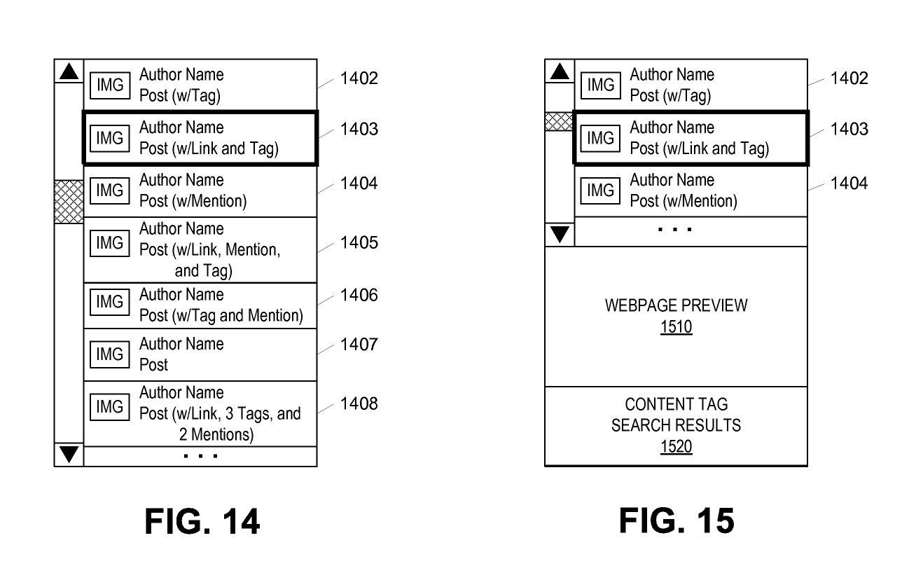

In step 306, the screen layout for the selected microblog post also may be determined based on the characteristics of the client display screen determined in step 305. For example, the type and amount of information displayed, including the number, size, and shape of screen windows displayed in the client user interface, may depend on the client display type (e.g., monitor, projection, or integrated display screen) and/or screen size (e.g., various mobile device screen sizes, tablet computers, laptop and desktop computers, etc.). For instance, when determining the layout for a larger client display screen, the layout selected may use more windows and display more additional pieces of data corresponding to the content elements in a microblog post. For smaller client display screens (e.g., mobile devices), a selected layout may use less windows and display less pieces of additional data. As shown in the examples below, the selected layout for a microblog post may also depend on the screen orientation (e.g., landscape FIGS. 5-13, portrait FIGS. 14-17), as well as other screen characteristics and capabilities. These examples illustrate, among other things, that a screen layout and other user interface features for a microblog post may be customized to make better use of the display screen space, improve loading time, and enhance the overall user experience.

As discussed above, the layout selected for displaying a microblog post may depend on, among other factors, the content of the post (e.g., the number and type of content elements within the post), and the display characteristics of the microblog client device 110 (e.g., screen size, device orientation, etc.). Therefore, as a user browses through a set of microblog posts and/or changes the currently selected post to a new post, some or all of the above method steps (e.g., at least steps 304 and 306) may be re-executed and the layout displayed by the microblog client 110 may change automatically in response to the browsing or selection of the new post. Additionally, if there is a change to the display characteristics of the client device 110, some or all of the above method steps (e.g., at least steps 305 and 306) may be re-executed and the layout displayed by the microblog client 110 may change automatically in response the detected change in display characteristics. As an example, if a user changes the orientation of a microblog client mobile device 110, for instance, by tilting or rotating the device to switch the device between portrait and landscape mode, the microblog client 110 may automatically re-determine and change the selected layout (e.g., the amount and type of information displayed, and the number, size, shape, and location of the screen windows displaying the information, etc.) for the microblog post being displayed at the time of the screen orientation change.

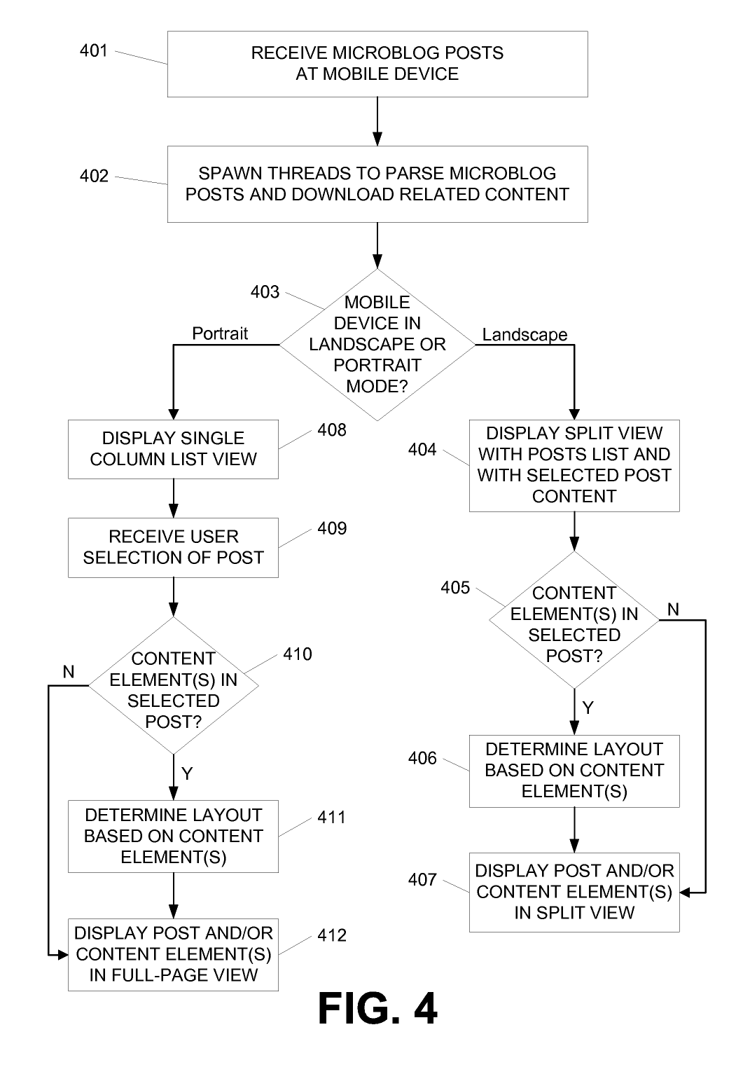

Referring now to FIG. 4, another flow diagram is shown illustrating a method of determining screen layouts and displaying microblog posts on a microblog client mobile device, according to one or more illustrative aspects described herein. In this example, the flow diagram in FIG. 4 illustrates a plurality of user interface modes that may be generated by an example client mobile device 110, for displaying lists of microblog posts and selected individual posts.

In step 401, the microblog client mobile device 110 receives a plurality of microblog posts, for example, from a microblog server 150, similar to step 301 discussed above. In step 402, the client application 120 of mobile device 110 spawns one or more process threads to parse the received microblog posts and download any additional content related to the posts. For example, dedicated process threads the client application 120 may identify links, terms marked with a hash tag (“#”) character, and usernames or identifiers denoted with the “@” character, or other content elements based on other designated characters or patterns. The process thread(s) may then download the target webpages for the identified links, sets of additional posts for the identified #tag terms, user profiles/biographical information for the identified @mention names, and additional information related to these and other content elements (e.g., Internet search results).

In step 403, if the mobile device 110 is oriented such that the device displays in landscape mode (403: Landscape), then in step 404 a split display view user interface may be generated by the client application 120. A split view may designate one portion of the client display screen for showing a list of the received microblog posts (e.g., in reverse chronologically order), and one or more other portions of the client display screen for showing a selected individual post and/or additional content related to the selected post. For instance, immediately after launching the microblog client application 120 on a mobile device 110 oriented in landscape mode, a horizontal split view display may be generated and displayed including a left window for displaying a set of posts in a vertical column and a right window for displaying a preview associated with a single post selected from the set of posts in the vertical column. See, e.g., FIGS. 5-13. The selected post may be user-selected or selected automatically by the client application 120, for example, as the most recent post in the set of received posts.

In step 405, if the selected post includes one or more content elements (e.g., link, mention, tag, etc.), then the right-side window(s) in the split view may show additional information corresponding to the content elements (e.g., target webpages for links, user bios or profiles for mentions, related posts or other information for tags, etc.). The split view layout for a microblog post including content element(s) may be determined in step 406. As discussed above in relation to step 306, determining a specific layout for a microblog post including one or more content elements may depend on several factors, such as, for example, the number and type of the content elements in the post, what additional information (if any) corresponding to the content elements has been pre-downloaded, and the size and other characteristics of the client display screen, among other possible factors. In step 407, the split view layout determined in step 406 for the microblog post is displayed in the display screen of the mobile device 110.

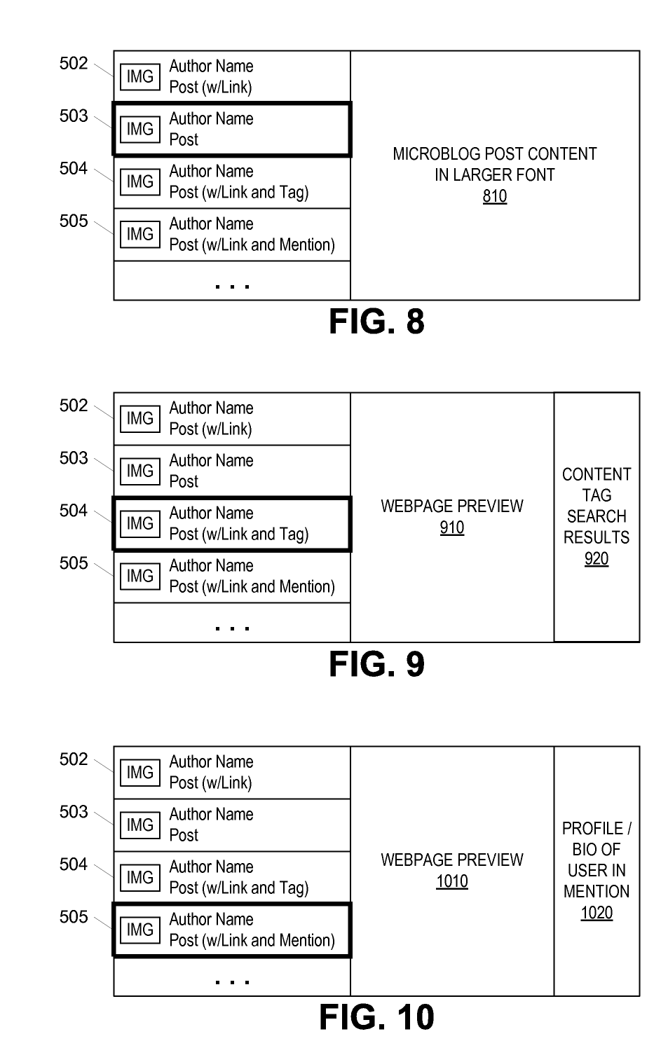

If the selected post does not include any identified content elements (405: No), then in step 407 the microblog client application 120 may display only the content of the post itself in the right-side window of the display screen. See, e.g., FIG. 8.

Returning to step 403, if the mobile device 110 is oriented such that the device displays in portrait mode (403: Portrait), then the client application 120 may display a single-column list view, rather than a split-view, in step 408. See, e.g., FIG. 14. In other examples, the microblog client application 120 may display a split view in which the display screen is split vertically instead of horizontally. See, e.g., FIG. 15.

In step 409, a selection (e.g., a click or tap by a user) of a microblog post is received via the client user interface, and in steps 410-412, the client application 120 determines a screen layout for the selected microblog post and displays the post on the user interface according to the screen layout. In this example, the process of identifying content elements in a microblog post (step 410), determining a screen layout for the post (step 411), and displaying the post (step 412), may be similar to the process described above in steps 405-407. For example, determining the screen layout for a microblog post may depend on several factors, such as, for example, the number and type of the content elements in the post, what additional information (if any) corresponding to the content elements has been pre-downloaded, and the size and other characteristics of the client display screen, among other possible factors. Additionally, when determining a screen layout for a post, similar techniques for dividing and using the available display screen space may be employed for horizontal split view layouts (e.g., FIGS. 5-13) and vertical split view layouts (e.g., FIGS. 15-17).

Referring now to FIG. 5, an example is shown of a user interface for a mobile device 110 oriented in landscape mode. In this example, the left side of the screen includes a list of microblog posts 502-505 and/or comments on posts in a timeline, for example. The list of posts 502-505 may be presented as hypertext objects that may be selected individually by the user. The list may include additional microblog posts above or below the displayed posts 502-505, which may be viewed by scrolling through the list using a scroll bar (not shown). Each microblog post 502-505 or comment on the left side of the screen may include basic information about the post, including the author's name and a picture or icon provided by the author. Each post 502-505 may also include at least some of the content of the post. In some examples, the full text content of the post or comment is displayed within each post 502-505 on the left side of the screen. Alternatively, in order to conserve screen space and/or to display larger numbers of posts on the screen at the same time, the full text content of the posts might not be displayed within each post 502-505 (e.g., zero characters, the first 20 characters, first 40 characters, etc.).

As shown in FIG. 5, the first post 502 has been selected and is highlighted on the left side of the screen. In this example, the client application 120 has determined that selected post 502 includes a link to a webpage (e.g., a full URL or bit.ly URL). Accordingly, webpage preview window 510 showing the target webpage is displayed when the post 502 is selected. As described above, target webpages and other additional content related to microblog posts may be pre-downloaded in certain embodiments. Therefore, displaying the webpage preview 510 upon selection of the post 502 may include retrieving the pre-downloaded webpage from the memory of the client mobile device 110 and rendering the previously stored web content in the preview window 510. However, if the target webpage was not pre-downloaded, then displaying the webpage preview 510 may include requesting and downloading the webpage from a remote web server in response the user-selection of the post 502. Additionally, as discussed above, the webpage preview 510 may include a complete version of the target webpage or only a portion of the target webpage.

Referring now to FIG. 6, another example is shown of a user interface for the mobile device 110 oriented in landscape mode. The first post 502 containing a webpage link has been selected and is highlighted on the left side of the screen. In this example, the client application 120 has provided two windows on the right side of the display screen, a webpage preview window 610 showing the target webpage, and a related links window 620 including one or more additional links related to the selected post 502. For instance, the related links window 620 may include a set of hyperlinks that are relevant to the subject or author of the post, and/or hyperlinks that are related to the target webpage 610. The links in the related links window 620 may be predetermined by a human editor and stored at the microblog server 150, or may be determined automatically by the client device 110 (e.g., via an Internet search engine query).

Referring now to FIG. 7, another example is shown of a user interface for the mobile device 110 oriented in landscape mode. The first post 502 containing a webpage link has been selected and is highlighted on the left side of the screen. In this example, the client application 120 has provided two windows on the right side of the display screen, a webpage preview window 710 showing the target webpage, and a user profile window 720 including additional information about the author of the selected post 502, for example, the author's user profile received from the microblog server 150 or other information about the author generated by the client device 110 (e.g., via an Internet search engine query).

Referring now to FIG. 8, another example is shown of a user interface for the mobile device 110 oriented in landscape mode. The second post 503 has been selected and is highlighted on the left side of the screen. In this example, the client application 102 has determined that the selected post 503 does not include any content elements. Accordingly, the determined screen layout includes a single window 810 on the right side of the screen showing the full text of the selected post in a larger font.

Referring now to FIG. 9, another example is shown of a user interface for the mobile device 110 oriented in landscape mode. The third post 504 has been selected and is highlighted on the left side of the screen. In this example, the client application 102 has determined that the selected post 504 includes a link (e.g., URL or bit.ly URL) and a content tag (e.g., “#” character followed by a keyword) denoting a topic or category associated with the post 504. Accordingly, the layout determined by the client application 120 includes two windows on the right side of the screen, a webpage preview window 910 showing the target webpage corresponding to the link in the post 504, and a search results window 920 corresponding to the content tag in the post 504. The search results window 920 may include, for example, a set of additional microblog posts retrieved from the microblog server 150 having the same content tag and/or Internet search results for the content tag.

Referring now to FIG. 10, another example is shown of a user interface for the mobile device 110 oriented in landscape mode. The fourth post 505 has been selected and is highlighted on the left side of the screen. In this example, the client application 102 has determined that the selected post 504 includes a link and a mention (e.g., “@” character followed by a microblog username). Accordingly, the layout determined by the client application 120 includes two windows on the right side of the screen, a webpage preview window 1010 showing the target webpage corresponding to the link in the post 505, and a user profile window 1020 corresponding to the mention in the post 505. The user profile window 1020 may including additional information about the user mentioned in the post 505, for example, the user's profile received from the microblog server 150, or other information about the user generated by the client device 110 (e.g., via an Internet search engine query).

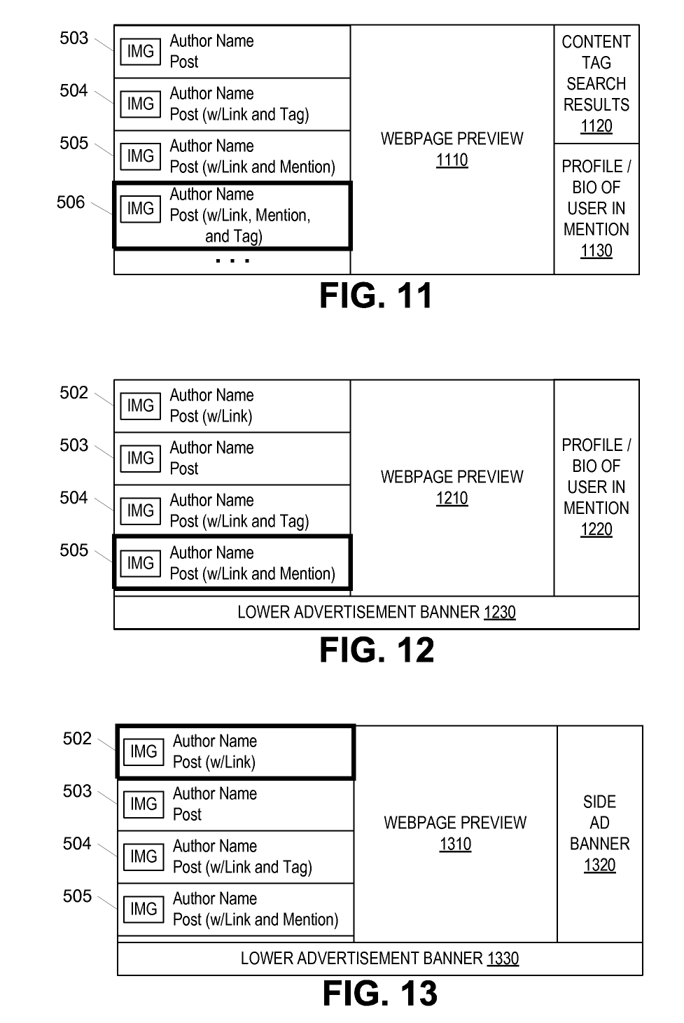

Referring now to FIG. 11, another example is shown of a user interface for the mobile device 110 oriented in landscape mode. The fifth post 506 has been selected and is highlighted on the left side of the screen. In this example, the client application 102 has determined that the selected post 504 includes three content elements, a link, and a mention, and a tag. Accordingly, the layout determined by the client application 120 includes three windows on the right side of the screen, a webpage preview window 1110 showing the target webpage in the post 506, and search results window 1120 showing the search results for the content tag in the post 506, and a user profile window 1130 showing a user profile or other biographical information for the user mentioned in the post 506.

Referring now to FIG. 12, another example is shown of a user interface for the mobile device 110 oriented in landscape mode. As in FIG. 10, the fourth post 505 has been selected and is highlighted on the left side of the screen, and the right side of the screen includes a webpage preview window 1210 and a user profile window 1220. Additionally, in this example, the client user interface includes an advertising banner 1230 across the lower portion of the screen. The advertising banner 1230 in this example may be persistent or temporary. The advertising content presented in advertising banner 1230 may be determined by the microblog client 110 and/or server 150 as relevant to the user or related to the selected microblog post 505. For example, the content of banner 1230 may be customized to relate the content of the target webpage 1210 or another content tag or mention in the current post 505 or a recently displayed post 502-504. The content of banner 1230 also may be based on the additional user information (e.g., the user's profile) stored at the microblog server 150.

Referring now to FIG. 13, another example is shown of a user interface for the mobile device 110 oriented in landscape mode. As in FIG. 5, the first post 502 has been selected and is highlighted on the left side of the screen, and the right side of the screen includes a webpage preview window 1310 showing the target webpage corresponding to the link in post 502. In this example, the client user interface includes two advertising banners 1320 and 1330. As noted above, the advertising content of the banners 1320 and 1330 may be based on the client user's profile, the subject of the displayed microblog post 502 or other microblog posts, or the content elements in the microblog posts.

Additionally, in certain embodiments, the number, size, and screen position of the advertisements in the user interface may be based on the content of the selected post 502 and/or the content elements identified in the post 502. For example, in FIG. 12, because the selected post 505 includes two content elements the client application 120 may determine that two content windows 1210 and 1220 and only a single advertising banner 1230 should be displayed. In contrast, in FIG. 13, because the selected post 502 includes only one content element the client application 120 may determine that two advertising banners 1320 and 1330 should be displayed.

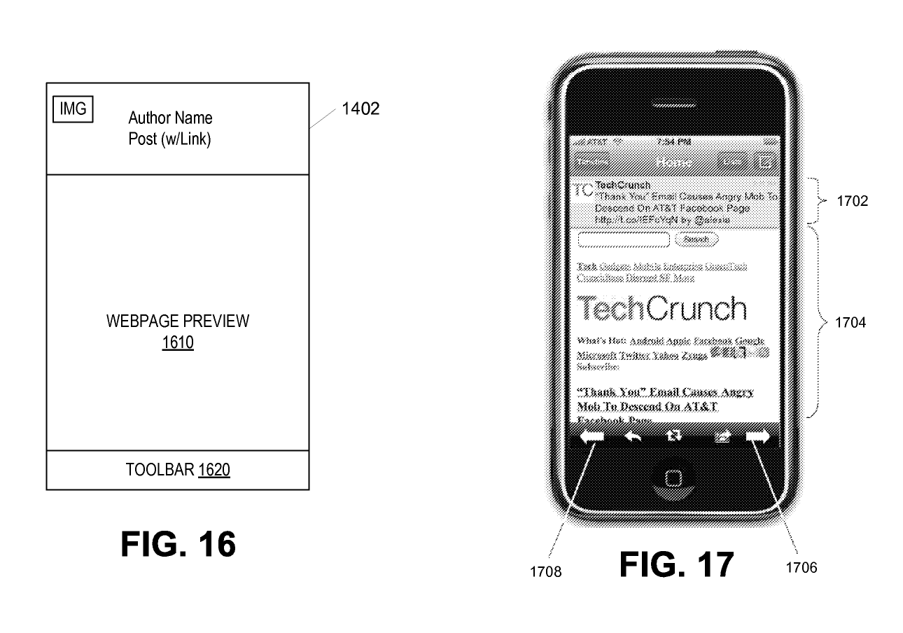

FIGS. 14-17 show additional examples a user interface for a mobile device 110 oriented in portrait mode. Referring to FIG. 14, the client application 120 has determined that the client mobile device 110 is oriented in portrait mode, and accordingly has selected a vertically aligned single-column view layout rather than a split view layout for displaying the list of microblog posts 1402-1408 and/or comments on posts in a timeline, for example. Because a split view layout is not used in this example, the client application 120 will not generate and display previews for the posts 1402-1408 when the user merely scrolls through the post list and various posts are highlighted, as shown in FIGS. 5-13. Rather, in this case, any additional information for a selected microblog post may be displayed in an individual post view (see FIGS. 16-17) only after only after the user selects the post within the single-column list view.

Referring now to FIG. 15, another example is shown of a user interface for a mobile device 110 oriented in portrait mode. In this example, although the client mobile device 110 is oriented in portrait mode, the client application 120 has selected a split view layout rather than the single-column view layout shown in FIG. 14. In general, split view layouts selected for mobile devices in portrait mode may contain some or all of the same features and information as the examples of split view layouts for mobile devices in landscape mode. Thus, in this example, the second post 1403 has been selected and is highlighted in the list of microblog posts at the top of the screen. The client application 102 has also determined that the selected post 1403 includes a link and a content tag denoting a topic or category associated with the post. Accordingly, the layout determined by the client application 120 includes two windows on the bottom portion of the screen, a webpage preview window 1510 showing the target webpage corresponding to the link in the post 1403, and a search results window 1520 corresponding to the content tag in the post 1403.

Referring now to FIGS. 16-17, two examples are shown of user interfaces for a mobile device 110 oriented in portrait mode. In these examples, a specific microblog post has been selected (e.g., by clicking-on, tapping, or otherwise selecting a post from FIG. 14 or FIG. 15), and in response the microblog client application 120 has selected and displayed an individual post view oriented for a mobile device 110 in portrait mode. The information retrieved and displayed in an individual post view may include the full text of the selected microblog post along with one or more windows showing additional information based on the content elements (e.g., links, mentions, tags, etc.) within the selected post. For example, in FIG. 16, the first microblog post 1402 has been selected, and the post text, author's name, and an image or icon associated with the author are displayed at the top of the screen. Additionally, because the selected post 1402 includes a link (e.g., URL or bit.ly URL), the client application 120 selects a layout including preview window 1610 displaying the target webpage. In FIG. 17, the microblog post 1702 including a shortened URL link has been selected. Accordingly, the client application 120 has selected a screen layout including a preview of the target webpage 1704 corresponding to the link in the post 1702.

FIGS. 16-17 each include a bottom toolbar (e.g., 1620) including options for navigating to different microblog posts and different views, as well as additional user interface options. For example, in FIG. 17, the toolbar includes a forward arrow button 1706 and a back arrow button 1708 to advance forward or backward, respectively, through the list of received microblog posts without requiring the user to return to a list of the retrieved posts and then select an individual post from the list. In this example, when the user presses the forward arrow button 1706, the client application 120 may determine and display a new screen layout for the next post in the list of retrieved posts.

As described above for other screen layouts, the screen layout selected by the client application 120 for an individual post view (e.g., FIGS. 16-17) may also be based on the number and type of content elements within the selected post. For example, a selected screen layout for a microblog post having multiple content elements may include a different designated screen window in the user interface for each content element found in the post. Additionally, the selected screen layout for individual posts may be based on which additional related content, if any, has been pre-downloaded and stored at the client mobile device 110. For example, if a microblog post includes multiple content elements (e.g., a link, two mentions, and three tags), but the client application 120 is configured to only pre-download target webpages for links and not to pre-download any additional content information for mentions and content tags, then the selected screen layout for the post may include a webpage preview window but no additional windows corresponding to the mentions or tags in the post.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive a plurality of microblog posts;
provide a user interface configured to display the plurality of microblog posts;
parse a first microblog post in the plurality of microblog posts to identify one or more content elements within the first microblog post;
determine a first layout for displaying the first microblog post in the user interface, wherein the first layout is based on the one or more content elements identified within the first microblog post, and wherein the first layout is selected from a plurality of different layouts; and
display the first microblog post via the user interface using the determined first layout.

2. The apparatus of claim 1, the memory storing further computer-readable instructions that, when executed by the at least one processor, cause the apparatus to:
identify a display device associated with the apparatus; and
determine one or more display characteristics of the display device,
wherein determining the first layout for displaying the first microblog post in the user interface is based on the one or more display characteristics of the display device.

3. The apparatus of claim 2, wherein the apparatus is a mobile device and wherein determining the one or more display characteristics comprises determining whether the mobile device is in a landscape mode or a portrait mode.

4. The apparatus of claim 1, wherein the one or more content elements identified within the first microblog post comprise at least one of: a uniform resource locator (URL), a mention identifying a user other than the author associated with the first microblog post, and a content tag identifying a keyword or topic associated with the first microblog post.

5. The apparatus of claim 1, the memory storing further computer-readable instructions that, when executed by the at least one processor, cause the apparatus to:
download additional information associated with the one or more content elements within the first microblog post; and
display the additional downloaded information in the user interface in response to a selection of the first microblog post.

6. The apparatus of claim 5, wherein the additional information associated with the one or more content elements is downloaded prior to the selection of the first microblog post.

7. The apparatus of claim 1, wherein the one or more content elements identified within the first microblog post comprises a first mention identifying a user other than the author associated with the first microblog post, the memory storing further computer-readable instructions that, when executed by the at least one processor, cause the apparatus to:
download a user profile corresponding to the first mention in the first microblog post, prior to selection of the first microblog post; and
display the user profile corresponding to the first mention concurrently with the first microblog post in response to a selection of the first microblog post.

8. The apparatus of claim 1, wherein the one or more content elements identified within the first microblog post comprises a first content tag identifying a keyword or topic associated with the first microblog post, the memory storing further computer-readable instructions that, when executed by the at least one processor, cause the apparatus to:
download a plurality of additional microblog posts associated with the identified keyword or topic in the first microblog post, prior to selection of the first microblog post; and
display the plurality of additional microblog posts concurrently with the first microblog post in response to a selection of the first microblog post.

9. A method, comprising:
receiving, at a microblog client device, a plurality of microblog posts;
providing a user interface configured to display the plurality of microblog posts;
parsing a first microblog post in the plurality of microblog posts to identify one or more content elements within the first microblog post;
determining a first layout for displaying the first microblog post in the user interface, wherein the first layout is based on the one or more content elements identified within the first microblog post, and wherein the first layout is selected from a plurality of different layouts; and
displaying, at the microblog client device, the first microblog post via the user interface using the determined first layout.

10. The method of claim 9, further comprising:
identifying a display device associated with the microblog client device; and
determining one or more display characteristics of the display device,
wherein determining the first layout for displaying the first microblog post in the user interface is based on the one or more display characteristics of the display device.

11. The method of claim 10, wherein the microblog client device is a mobile device and wherein determining the one or more display characteristics comprises determining whether the microblog client device is in a landscape mode or a portrait mode.

12. The method of claim 9, wherein the one or more content elements identified within the first microblog post comprise at least one of: a uniform resource locator (URL), a mention identifying a user other than the author associated with the first microblog post, and a content tag identifying a keyword or topic associated with the first microblog post.

13. The method of claim 9, further comprising:
downloading additional information associated with the one or more content elements within the first microblog post; and
displaying the additional downloaded information in the user interface in response to a selection of the first microblog post.

14. The method of claim 13, wherein the additional information associated with the one or more content elements is downloaded prior to the selection of the first microblog post.
